(19) United States
(12) Patent Application Publication
(10) Pub. No.: US 2026/0080619 A1
(43) Pub. Date: Mar. 19, 2026

(54) GEOMETRICALLY ACCURATE IMPLICIT SCENE REPRESENTATION

(71) Applicant: Shenzhen Yinwang Intelligent Technologies Co., Ltd., Shenzhen (CN)

(72) Inventors: Moussab Bennehar, Boulogne Billancourt (FR); Fusang Wang, Shenzhen (CN); Nathan Piasco, Boulogne Billancourt (FR); Luis Roldao Jimenez, Boulogne Billancourt (FR); Dzmitry Tsishkou, Boulogne Billancourt (FR); Arnaud Louys, Shenzhen (CN)

(73) Assignee: Shenzhen Yinwang Intelligent Technologies Co., Ltd., Shenzhen (CN)

(21) Appl. No.: 19/394,077

(22) Filed: Nov. 19, 2025

Related U.S. Application Data
(63) Continuation of application No. PCT/EP2023/063583, filed on May 22, 2023.

(51) Int. Cl. G06T 17/00; G06N 3/08; G06T 7/12; G06V 20/56

(52) U.S. Cl. CPC G06T 17/00; G06N 3/08; G06T 7/12; G06V 20/588

(57) ABSTRACT

The present disclosure relates to the geometrically accurate reconstruction of a scene based on an implicit representation provided by a neural network. A method of reconstructing an environment of at least one camera device can include capturing by the at least one camera device a plurality of images of an environment of the at least one camera device. The method can also include obtaining an implicit representation of the environment based on the plurality of images by means of a neural network and reconstructing the environment based on the implicit representation, including reconstructing at least one object of the environment having a flat surface. The implicit representation is obtained based on an objective function of the neural network comprising a regularization term obtained based on Singular Value Decomposition.

### CROSS-REFERENCE TO RELATED APPLICATIONS

This application is a continuation of International Application No. PCT/EP2023/063583, filed on May 22, 2023, the disclosure of which is hereby incorporated by reference in its entirety.

### TECHNICAL FIELD

The present disclosure relates to geometrically accurate reconstruction of a three-dimensional scene comprising at least one substantially flat object based on a neural network configured for processing two-dimensional images and trained for obtaining an implicit representation of the scene.

### BACKGROUND

Localization is an important task for the operation of vehicles as automobiles, Automated Guided Vehicles (AGV) and autonomous mobile robots or other mobile devices as smartphones. For example, LIDAR-camera sensing systems comprising one or more Light Detection and Ranging (LIDAR) device configured for obtaining a temporal sequence of 3D point cloud data sets for sensed objects and one or more camera devices configured for capturing a temporal sequence of 2D images of the objects are employed in automotive applications. In the automotive context, the LIDAR-camera sensing systems can be comprised by Advanced Driver Assistant Systems (ADAS).

High Definition (HD) mapping is crucial for a variety of self-driving and ADAS core modules and algorithms. In this context, accurately representing the scene geometry is crucial to localize detected lanes and lane markings, for example, which is often done by using one or multiple cameras, and/or LiDARs. In the art detected lanes are projected to the real world (lifted from 2D images to the world 3D space) either using Inverse Perspective Mapping (IPM) transformation or using measured depth using LiDAR sensors, for example. IPM transformation is based on a flat world assumption, however, and suffers from blurring and stretching of the faraway scene. The LiDAR approach can be cumbersome, expensive, requires accurate calibration and distortion-less capturing of 3D point clouds and may suffer from sparsity of data for regions far away from the vehicle.

Recently, neural network techniques for implicitly modelling a scene through volume rendering resulting in a geometrically accurate 3D model from 2D supervision have evolved. For example, the Neural Radiance Field (NeRF) technique introduced by B. Mildenhall et al. in a paper, entitled “Nerf. Representing scenes as neural radiance fields for view synthesis” in “Computer Vision—ECCV 2020”, 16^{th} European Conference, Glasgow, UK, August 23-28, 2020, Springer, Cham, 2020, or any advancement thereof has nowadays become a favorite tool for view synthesis.

Regarding applications for HD mapping and scene editing in general, NeRF techniques, unfortunately, can suffer from overfitting to training views resulting in poor geometry reconstruction, particularly, of low-texture 2D surfaces. Sparsity of training data (which is typical in driving scenarios) may also result in relatively poor reconstruction of a scene with respect to the correct geometry.

RegNeRF proposed by M. Niemeyer et al., “RegNeRF: Regularizing Neural Radiance Fields for View Synthesis from Sparse Inputs”, Proceedings of the IEEE/CVF Conference on Computer Vision, 10413-10422, 2022, comprises plane regularization of the geometry based on the Total Variation (TV) of the rendered patches of depth on additional unseen camera views. RegNeRF training of a neural network is based on an objective function including the conventional photometric loss and, additionally, a regularization term (e.g., loss) to minimize depth differences between adjacent pixels. The basic hypothesis underlying RegNeRF is that the real world is piece-wise smooth, which is not always true. In addition, based on its mathematical formulation, it forces the surface of the regularized patch to be orthogonal to the central ray of the patch which may result in inaccurate reconstruction of the geometry of the scene.

### SUMMARY

In view of the above, it is an objective underlying the present application to provide a technique for accurately reconstructing the geometry of a scene captured by a camera based on an implicit representation provided by a neural network, for example, for HD mapping purposes.

The foregoing and other objectives are achieved by the subject matter of the independent claims. Further embodiments and implementation forms are apparent from the dependent claims, the description and the figures.

According to a first aspect, it is provided a method of reconstructing an environment of at least one camera device, comprising capturing by the at least one camera device a plurality of images of an environment of the at least one camera device, obtaining an implicit representation of the environment based on the plurality of images by means of a neural network and reconstructing the environment based on the implicit representation comprising reconstructing at least one object of the environment having a flat surface. The implicit representation is obtained based on an objective function of the neural network comprising a (plane) regularization term obtained based on Singular Value Decomposition (SVD).

It goes without saying that herein the term “neural network” refers to an artificial neural network. The camera device may, for example, be a Time-of-Flight camera, depth camera, etc. The camera device may be installed on a vehicle, for example, a fully or partially autonomous automobile, an autonomous mobile robot or an Automated Guided Vehicle (AGV). The object may have exactly one single observable flat surface and it may be a street, a road or a sidewalk.

The geometric accuracy of the implicit representation and, thus, the reconstruction of the captured environment is significantly increased as compared to the art by employing the regularization term obtained based on SVD used for the training of the neural network. Similar to the teaching by M. Niemeyer et al. in the paper cited in the background section points of reconstructed images are forced to lie on a plane in order to enhance geometric accuracy, particularly, of flat surfaces. However, contrary to the teaching by M. Niemeyer et al. according to the method of the first aspect plane regularization is achieved by SVD applied to the predicted geometry given by the learned implicit representation as it is described in detail in the detailed description below. In particular, according to the method of the first aspect surfaces of the regularized rendered patches of reconstructed images are not forced to be orthogonal to the central rays of the respective patches.

The method of the first aspect allows for an improved accuracy of geometry and improved appearance of reconstructed environments as compared to the art based on a very compact implicit representation. Objects with flat surfaces can be reliably reconstructed and localized which beneficial for tasks as the generation of High definition (HD) maps, HD mapping, and autonomous driving, in general. Particularly, the reconstruction and recognition of streets and roads and street markings and road markings of the same can be reliably achieved with high accuracy based on the method of the first aspect.

The neural network may comprise a (deep) Multilayer Perceptron (MLP) (fully connected feedforward) neural network. According to an embodiment of the method of the first aspect, the neural network may be trained based on the Neural Radiance Field (NeRF) technique introduced by B. Mildenhall et al. in a paper, entitled “Nerf. Representing scenes as neural radiance fields for view synthesis” in “Computer Vision—ECCV 2020”, 16^{th} European Conference, Glasgow, UK, Aug. 23-28, 2020, Springer, Cham, 2020, or any advancement thereof that nowadays have become a favorite tool for view synthesis (see also detailed description below). According to this embodiment, the implicit representation is a Neural Radiance Field (NeRF) representation comprising color and depths values. Such a NeRF representation allows for a realistic reconstruction of the environment with relatively low demands for computational resources and memory space.

According to another embodiment, the objective function used for training the neural network further comprises a photometric loss function representing differences between training images and images reconstructed based on the training images, the accurate poses of one or more cameras used for providing the training images and implicit representations thereof (see also detailed description below). Such an objective function can be used for fast and efficient training of the neural network.

According to another embodiment, the method of the first aspect or any of the above-described embodiments thereof further comprises applying semantic masks to the plurality of images for identifying regions of the plurality of images showing the at least one object and wherein only the implicit representation of the at least object is obtained based on the objective function comprising the regularization term. In other words, the regularization is only applied to regions of the captured images that are identified to be suitable for the regularization, for example, regions representing (parts of) streets or roads of the environment. By targeting by means of the semantic masks some classes of objects that are inherently flat the geometry of non-flat world objects is not distorted which may enhance the overall accuracy of the reconstruction process. For these classes of objects defined by the semantic masks, it is reasonable to assume that the objects are locally flat (piece-wise smooth). The implicit representation of regions not showing the at least one object may be obtained based on another objective function comprising a photometric loss function and not comprising the regularization term.

The semantic masks may be provided by a pre-trained other neural network or an algorithm providing semantic information. For example, the pre-trained other neural network is a transformer. Deep learning techniques provide for semantic masks with a reliably high degree of sensitivity of object differentiation.

In principle, the neural network may be trained from the scratch based on the objective function. Alternatively, an already trained neural network may be re-trained for plane regularization. Thus, according to an embodiment, the method of the first aspect further comprises providing an initial neural network trained based on an initial objective function not comprising the regularization term and training the initial neural network based on the objective function comprising the regularization term to obtain the neural network. The initial objective function may comprise a photometric loss function. Re-training an already trained neural network to account for plane regularization may be performed faster than training a neural network from the scratch.

According to another embodiment, the method of the first aspect or any embodiment thereof further comprises training at least one of the neural network and the initial neural network with respect to the regularization term of the objective function in an unsupervised manner, i.e., no priors are needed for accounting for plane regularization thereby enhancing the flexibility of the plane regularization. In particular, no normal priors are needed.

According to an embodiment, the training of the at least one of the neural network and the initial neural network based on minimizing the objective function may comprise obtaining an implicit representation of a training scene captured by one or more camera devices, reconstructing the training scene based on the implicit representation of the training scene by volume rendering based on ray marching, dividing the reconstructed training scene into reconstructed training scene patches and applying for selected ones of the reconstructed training scene patches an SVD on a set of termination points of the rays obtained by the ray marching and obtaining for the selected ones of the reconstructed training scene patches the respective smallest singular value of the singular matrix of the respective SVD. The regularization term comprises the sum of the smallest singular values of the singular matrices of the SVDs applied to the sets of termination points of the rays for the selected reconstructed training scene patches. According to this embodiment reconstructing the environment based on the implicit representation obtained based on an objective function of the neural network comprising a (plane) regularization term obtained based on SVD implies reconstructing the environment based on the implicit representation obtained by a neural network trained based on the objective function comprising the sum of the smallest singular values of the singular matrices of the SVDs applied to the sets of termination points of the rays for the selected reconstructed training scene patches.

Selection of the selected reconstructed training may be performed by applying the above-described semantic masks such that only regions comprising flat surfaces, for example, are used for the training based on the SVD.

The regularization term may comprise a real-valued weighting term larger than zero to control the influence of the regulation term on the entire objective function. For example, a larger weighting term may be used for re-training for plane regularization an already trained neural network than for training for plane regularization a neural network from the scratch.

As already noted above the method of the first aspect (as well as each implantation thereof) may be used in the context of the generation of High definition (HD) maps (HD mapping) and autonomous driving, in general, and, particularly, the reconstruction and recognition of streets and roads and street markings and road markings. The reconstructed environment and hence generated novel RGB views can, in fact, be used in any vision-based pipeline.

Thus, according to an implantation, the method of the first aspect or any implantation thereof may further comprise generating or labeling a High Definition (HD) map by means of the reconstructed at least one object.

According to a further embodiment, a method of recognizing a road, a street or a lane based on the reconstructed at least one object and a method of autonomously driving a vehicle based on the reconstructed at least one object are provided.

At least one of the operations of the method according to the first aspect and embodiments thereof may be performed at a device site (for example, a vehicle) with even limited computational resources of the embedded computational system or at a remote site that is provided with the data needed for processing.

According to a second aspect, a computer program product comprising computer readable instructions for, when run on a computer performing or controlling the operations of the method according to the first aspect or any embodiment thereof is provided. The computer may be installed in a vehicle, for example, a vehicle equipped with the at least one camera device and the neural network.

According to a third aspect, a neural network is provided that is configured for receiving input data based on a plurality of images captured by at least one camera device representing an environment of the at least one camera device and for obtaining an implicit representation of the environment based on the input data, wherein the neural network is trained based on an objective function comprising a regularization term based on Singular Value Decomposition (SVD).

According to an embodiment of the neural network of the third aspect, implicit representation is a Neural Radiance Field (NeRF) representation, i.e., the neural network is a NeRF trained neural network. The objective function may further comprise a photometric loss function. The regularization term may comprise a real-valued weighting term larger than zero to control the influence of the regulation term on the entire objective function during training of the neural network.

According to an embodiment, the neural network of the third aspect a neural network trained by a training procedure comprising obtaining an implicit representation of a training scene captured by one or more camera devices, reconstructing the training scene based on the implicit representation of the training scene by volume rendering based on ray marching, dividing the reconstructed training scene into reconstructed training scene patches and applying for selected ones of the reconstructed training scene patches an SVD on a set of termination points of the rays obtained by the ray marching and obtaining for the selected ones of the reconstructed training scene patches the respective smallest singular value of the singular matrix of the respective SVD. The regularization term comprises the sum of the smallest singular values of the singular matrices of the SVDs applied to the sets of termination points of the rays for the selected reconstructed training scene patches.

According to a fourth aspect, a system comprising at least one camera device, the neural network according to the third aspect or any embodiment thereof and a processing unit configured for performing or controlling the operations of the method of the first aspect or any embodiment thereof is provided.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 illustrates a technique of reconstructing a scene based on plane regularization according to an embodiment.

FIG. 2 illustrates training of a neural network for reconstructing a scene based on plane regularization according to an embodiment.

FIG. 3 illustrates plane regularization according to an embodiment.

FIG. 4 illustrates re-training of an already trained neural network for reconstructing a scene based on plane regularization according to an embodiment.

FIG. 5 is a flow chart illustrating a method of reconstructing an environment of at least one camera device according to an embodiment.

FIG. 6 illustrates a system comprising a camera device, a neural network, and a processing unit according to an embodiment.

### DETAILED DESCRIPTION OF THE EMBODIMENTS

Herein, it is provided a method of reconstructing an environment of at least one camera device, for example, a camera device installed on a vehicle. Particularly, the method may be based on Neural Radiance Field (NeRF) scene representation wherein the NeRF neural network is trained by an objective function comprising a plane regularization term based on Singular Value Decomposition (SVD). The neural network may be trained from the scratch or an already trained neural network may be re-trained based on the objective function comprising the plane regularization term. By the provided method the geometry of the environment, in particular, flat surfaces, can be accurately reconstructed such that HD mapping can be facilitated based on implicit representations of the environment, for example. Whereas the following description of embodiments refers to the NeRF techniques other techniques for implicit representation of environments/scenes based on neural fields and volumetric rendering might be suitably used in alternative embodiments.

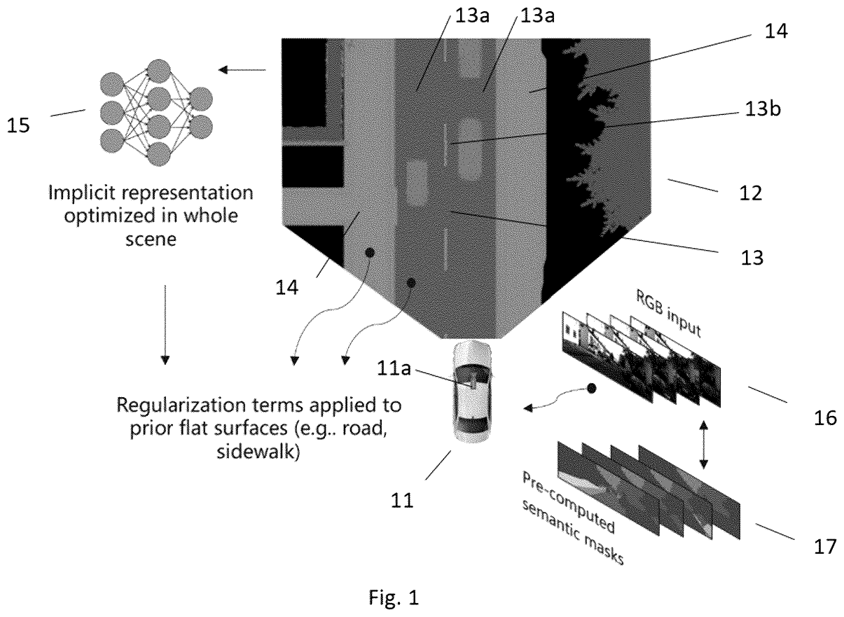

FIG. 1 illustrates principles of a technique of reconstructing a scene/environment according to an embodiment. In the shown scenario, a vehicle (e.g., an automobile) 11 is equipped with one or more cameras 11a for capturing an environment 12. The environment 12 comprises a street 13 and sidewalks 14. The street 13 comprises two lanes 13a separated by road markings 13b.

Further, the vehicle 11 is equipped with or in data communication with a neural network 15 configured for obtaining an implicit representation of the environment. According to a particular embodiment, the neural network comprises or consists of one or more (deep) multilayer perceptrons (MLPs), i.e. it comprises or is a fully connected feedforward neural network, that is trained based on the Neural Radiance Field (NeRF) technique as proposed by B. Mildenhall et al. in a paper, entitled “Nerf: Representing scenes as neural radiance fields for view synthesis” in “Computer Vision—ECCV 2020”, 16^{th} European Conference, Glasgow, UK, Aug. 23-28, 2020, Springer, Cham, 2020, or further developments thereof, for example, Nerf-W; see R. Martin-Brualla et al., “NeRF in the Wild: Neural Radiance Fields for Unconstrained Photo Collections”, in IEEE Conference on Computer Vision and Pattern Recognition, CVPR 2021, Jun. 19-25, 2021, pages 7210-7219, Computer Vision Foundation, IEEE, 2021. NeRF, as originally introduced by B. Mildenhall et al. allows for obtaining a neural network implicit representation of the environment based on color values and spatially-dependent volumetric density values (representing the neural field).

Input data for the neural network represent 3D locations and viewing directions (θ, φ) (camera poses) and the NeRF trained neural network outputs view dependent color values (for example RGB) and volumetric density values σ. Thus, the MLP realizes F_{Θ}: (x, y, z, θ, φ)→(R, G, B, σ) with optimized weights Θ obtained during the training process.

The volumetric rendering is based on rays passing through the scene (cast from all pixels of images). The volumetric density σ(x, y, z) can be interpreted as the differential probability of a ray terminating at an infinitesimal particle at (x, y, z). By gathering all the volumetric density values along the ray direction, the accumulated transmittance T(s) along the ray direction can be computed

$$T ( s ) = exp ( - {\int }_{0}^{s} σ ( r ( l ) ) dl ) .$$

The accumulated transmittance T(s) along the ray from its origin 0 to s represents the probability that the ray travels its path to s without hitting any particle.

The implicit representation (i.e., neural field) is queried at multiple locations along the rays and then the resulting samples are composed into an image.

According to the embodiment the objective functions used for NeRF training known in the art are modified by the introduction of a (plane/geometry) regularization term (loss) applied to flat surfaces as, for example, the street 13 and the sidewalks 14. Details on the regularization term are given below. Images 16 captured by the at least one camera 11a of the vehicle 11 are subject to masking by pre-provided semantic masks 17 designed for identifying (objects comprising) flat surfaces to regularize only objects of object classes that are flat in real life. For example, the semantic masks 17 are provided by deep learning techniques. According to an embodiment, the semantic masks 17 are provided by a transformer neural network, for example, the Mask2Former (B. Cheng et al., “Masked-attention Mask Transformer for Universal Image Segmentation”, IEEE Conference on Computer Vision and Pattern Recognition, CVPR 2022).

Due to the application of the regularization loss, flat surfaces can be geometrically accurately reconstructed and highly accurate HD mapping can be achieved based on the implicit representations of the neural network trained based on the objective function comprising the regularization term.

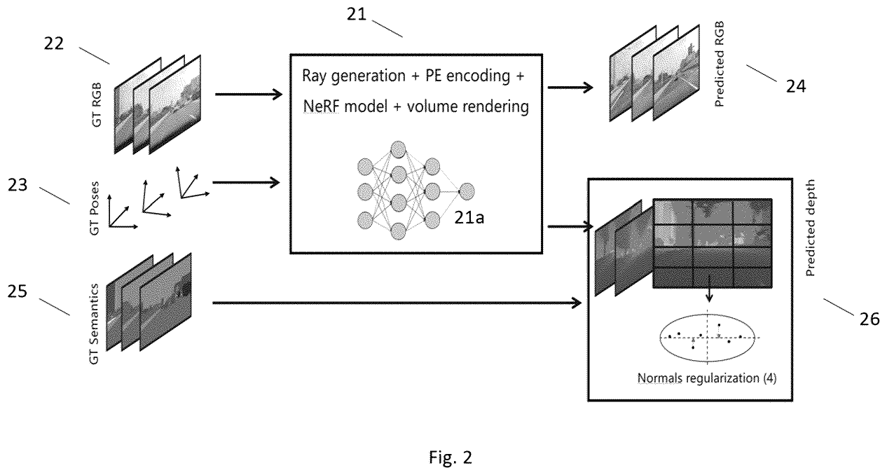

Training of a neural network for reconstructing a scene based on plane regularization according to an embodiment is illustrated in FIG. 2. The trained neural network 21a may be used for road/lane/lane marking recognition and generation and labelling of HD maps, etc. For example, 3D HD maps may be labelled by the positions of lanes and roads as well as street/road markings obtained by the neural network 21a.

FIG. 2 shows a processing system 21 comprising a neural network 21a configured for obtaining an implicit representation of a scene, for example, based on the NeRF technology. For training the neural network 21 input data based on ground truth (GT) images 22 and GT camera poses 23 is input into the processing system 21/neural network 21a. The neural network 21a is trained for an implicit representation of the scenes captured by the images 22. The scenes are reconstructed in form of predicted RGB images 24 by volume rendering by the processing system 21 based on color and depths values output by the neural network 21a. Training of the neural network 21a comprises minimizing photometric losses, i.e., differences between the predicted RGB images 24 and the GT images 22.

The training objective for the photometric loss can be defined by:

$$arg {min}_{θ} {\sum }_{n}^{N} ‖ {I}_{n} - {I}_{θ} ( {T}_{n} , {K}_{n} ) ‖ , \qquad ( equation 1 )$$

where θ denotes trainable parameters of the implicit NeRF representation (i.e., the weights of the neural network), Iₙ is the training image n, n∈N, and I_{θ}(Tₙ, K) is the NeRF-generated (volumetrically rendered) image at pose Tₙ (pose of image Iₙ) with camera parameter Kₙ (camera parameter, for example, resolution, field of view, etc., of image Iₙ) with a suitable norm ∥ . . . ∥. For example, the L2 norm (L2 loss function) may be employed.

However, according to the embodiment illustrated in FIG. 2 the neural network 21 is not only trained based on the photometric loss of equation 1. Rather, GT semantic maps 25 are applied to the GT images 22 provided by the neural network 21a in order to identify/define patches or regions comprising flat surfaces (for example, parts of roads or streets or lanes) and to identify/define the corresponding rendered patches (or sub-patches thereof) in depths maps provided by the neural network 21a. For the thus identified/defined regions (sub-patches), the training objective of equation 1 is supplemented by a regularization term.

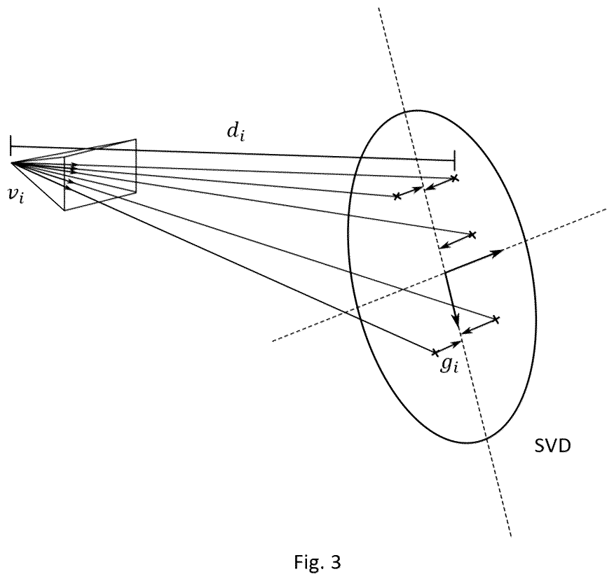

For the classes of objects identified by the semantic masks 25 it is reasonable to assume that the objects are locally flat. The expected 3D termination point (i.e. predicted depth) pᵢ of a ray given by its origin oᵢ and direction vᵢ is pᵢ=oᵢ+dᵢ vᵢ, where dᵢ is its expected depth that can be obtained from NeRF through ray marching (cf. also FIG. 3). The least square plane of the set (point cloud) of termination points P=[p₁, . . . , p_{N}]^{T} in a region (rendered patch or sub-patch thereof) defined by a semantic mask 25 can be defined by the solution of the minimization problem:

$$arg {min}_{{p}_{c} , n} {\sum }_{i}^{N} {( ( {p}_{i} - {p}_{c} ) \cdot n )}^{2} , \qquad ( equation 2 )$$

with a suitably chosen point p_{c} (for example, the barycentre of the set of points P) and normal vector n.

Solution of the minimization problem translates to a singular value decomposition of the set of points P:

$$P = {USV}^{T} , \qquad ( equation 3 )$$

$$with$$

$$U = [ {u}_{1} , {u}_{2} , {u}_{3} ] , S = [ \begin{matrix}{σ}_{1} & 0 & 0 \\ 0 & {σ}_{2} & 0 \\ 0 & 0 & {σ}_{3}\end{matrix} ] , V = [ {υ}_{i , j} ]$$

where U is the matrix of left singular vectors, S is a diagonal matrix of sorted singular values and V is the matrix of right singular vectors (UU^{T}=VV^{T}=I₃ with the identity matrix I). To enforce the rendered 3D patch points to lie on a plane, the smallest singular value (i.e. σ₃, since the singular values are sorted in descending order) is to be minimized. Minimization of the smallest singular value pushes the 3D points pᵢ towards a plane that is spanned by the first two left column vectors of U (i.e. u₁ and u₂), without requiring any prior (i.e. in an unsupervised way). Different from the art no surface normal priors are required. In principle, avoiding the need of normal priors allows for handling a wider cases of objects such as slanted surfaces or none-object-centered cases.

The normal to the local plane is hence given by the vector u₃. For a batch b of ray patches, an additional regularization term is appended to the regular photometric loss L_{MSE} of NeRF (cf. equation 1) as follows:

$$ℒ = {ℒ}_{MSE} = λ {\sum }_{i = 1}^{b} {σ}_{{3}_{i}} , λ > 0 , \qquad ( equation 4 )$$

wherein λ denotes a real-numbered weighting term used to balance both optimization terms to each other and L denotes the overall loss function that is to be to be minimized.

Application of the thus defined regularization term allows for geometrically accurate reconstruction of flat objects and thus accurate HD mapping of streets, roads, lanes and markings of the same. An unsupervised geometry regularization alongside the learning of an implicit representation based on the photometric loss function without any additional sensor information results in a geometrically accurate model/reconstructing of a real scene captured by one or more cameras. Particularly, accurate reconstruction of flat surfaces and a synthesis of novel views that are accurate in appearance and geometry even at extreme viewing positions that differ significantly from training poses can be achieved. Road features as markings can be reconstructed geometrically and photometrically accurate, for example, with no line breaking of continuous road marking lines. The constructed flat surfaces and road features comprises by the flat surfaces can be used for road/street recognition, autonomous driving control, generation and labelling of HD maps, etc.

The training of implicit models may be relatively time expensive and may require complex computational resources and large memories depending on the chosen model. Hence, the training of the neural network 21a may be carried out on a powerful server after data has been acquired from a car or fleet of cars equipped with camera devices. It is worth mentioning that the proposed solution slightly increases computation time since it involves computing the SVD decomposition of small image patches. On the other hand, inference can be done either on the same remote server or a client (for example, installed on a vehicle) since it requires less computation time. In particular, including the regularization term for training the neural network 21a does not increase inference time since it is not involved during the inference process itself.

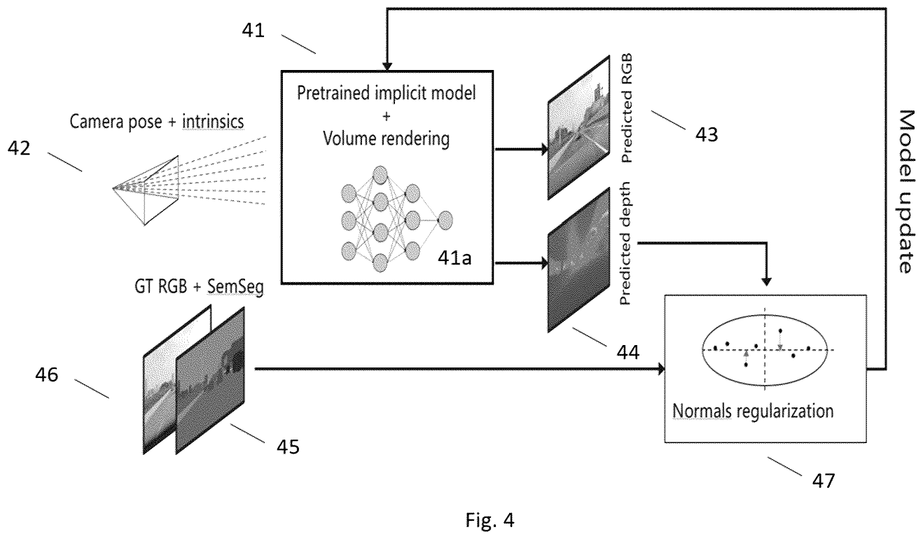

Rather than training a neural network from the scratch, an already trained neural network may be re-trained for geometry regularization as it is illustrated in FIG. 4. The processing system 41 comprises a neural network 41a already trained for implicitly representing a scene, for example, a NeRF trained neural network, that is trained based on the training objective defined in equation 1, for example. For re-training the neural network 41a input data based on ground truth images and GT camera poses 42 is input into the processing system 41/neural network 41a. Predicted RGB images 43 and predicted depths maps 44 are output by the neural network 41a. The predicted depths maps 44 are used for the re-training of the neural network 41a. GT semantic maps 45 are applied to GT RGB images 46 in order to identify/define patches or regions comprising flat surfaces (for example, parts of roads or streets or lanes) and to identify the corresponding regions of predicted depths maps 44 (divided into patches) provided by the neural network 41a. For the thus identified/defined patches or sub-patches thereof of the depths maps 44 (and only for these), the training objective of equation 1 is supplemented by the regularization term shown in equation 4 for plane normals regularization 47 and updating the model already learned by the neural network 41a.

By online fine-tuning a pre-trained implicit model that does not show the correct geometry based on the regularization term geometrically highly accurate implicit models can be obtained without starting from the scratch thereby accelerating training speeds.

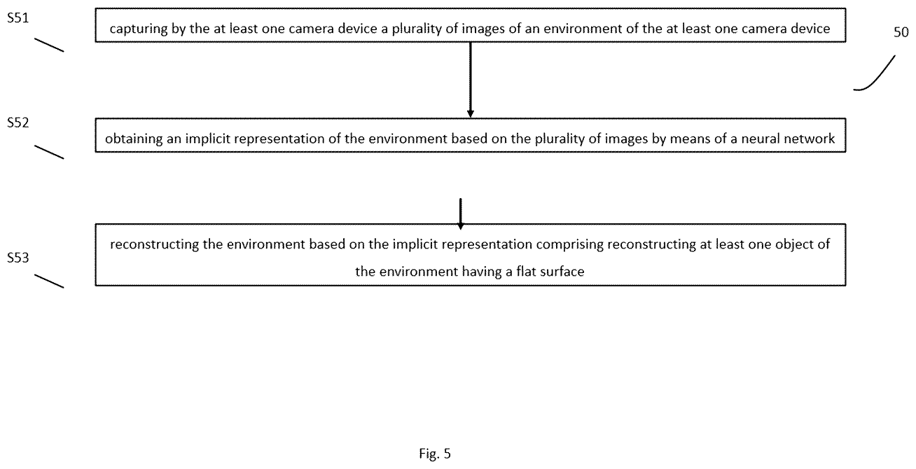

An embodiment of a method 50 of reconstructing an environment of at least one camera device according to an embodiment is illustrated in the flow chart of FIG. 5. The method 50 comprises capturing S51 by the at least one camera device a plurality of images of an environment of the at least one camera device. Further, the method 50 comprises obtaining S52 an implicit representation of the environment based on the plurality of images by means of a neural network and reconstructing S53 the environment based on the implicit representation comprising reconstructing at least one object of the environment having a flat surface. The implicit representation is obtained based on an objective function of the neural network comprising a regularization term obtained based on SVD as described above, particularly, with reference to FIG. 2. Furthermore, according to an embodiment the plane regularization by means of the regularization term may be only applied to regions of the images and corresponding regions of depths maps provided by the neural network that are identified as comprising flat objects wherein the identification is obtained based on semantic masks (see also description above).

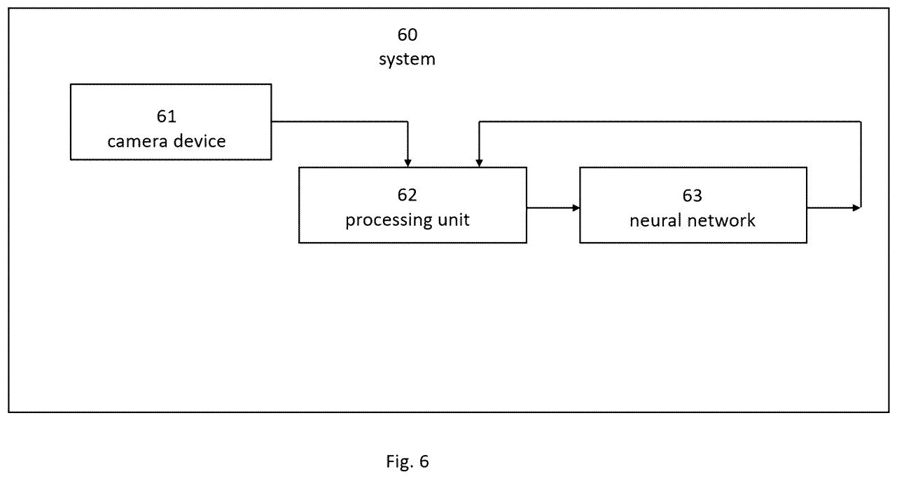

FIG. 6 illustrates a processing system 60 according to an embodiment. The processing system 60 may be configured to implement any of the procedures described with reference to FIGS. 1 to 4. The method 50 illustrated in FIG. 5 may be implemented in the processing system 60.

The processing system 60 comprises at least one camera device 61 for capturing images of an environment of the camera device 61. The processing system 60 further comprises a neural network 62 configured for receiving input data based on the images captured by the camera device 61 and obtaining an implicit representation of the environment based on the input data. The neural network 52 is trained based on an objective function comprising a regularization term based on Singular Value Decomposition. Furthermore, the processing system 16 comprises a processing unit 63. The processing unit 63 is configured for processing the outputs provided by the neural network 62 and performing volumetric rendering based on these outputs. It can be configured for performing or controlling the operations of the method 50 illustrated in FIG. 5.

The embodiments of methods and apparatuses described above can be suitably integrated in vehicles as automobiles, Automated Guided Vehicles (AGV) and autonomous mobile robots to facilitate navigation, localization and obstacle avoidance. In the automotive context, the embodiments of methods and apparatuses described above can be comprised by ADAS. Further embodiments of methods and apparatuses described above can be suitably implemented in augmented reality applications.

All previously discussed embodiments are not intended as limitations but serve as examples illustrating features and advantages of the invention. It is to be understood that some or all of the above-described features can also be combined in different ways.

What is claimed is:

1. A method of reconstructing an environment of at least one camera device, comprising
capturing by the at least one camera device a plurality of images of an environment of the at least one camera device;
obtaining an implicit representation of the environment based on the plurality of images generated by a neural network; and
reconstructing the environment based on the implicit representation comprising reconstructing at least one object of the environment having a flat surface;
and wherein the implicit representation is obtained based on an objective function of the neural network comprising a regularization term obtained based on Singular Value Decomposition (SVD).

2. The method according to claim 1, wherein the implicit representation is a Neural Radiance Field (NeRF) representation.

3. The method according to claim 1, wherein the objective function further comprises a photometric loss function.

4. The method according to claim 1, further comprising:
applying semantic masks to the plurality of images for identifying regions of the plurality of images showing the at least one object and wherein only the implicit representation of the at least one object is obtained based on the objective function.

5. The method according to claim 4, wherein the implicit representation of regions not showing the at least one object are obtained based on another objective function comprising a photometric loss function and not comprising the regularization term.

6. The method according to claim 4, wherein the semantic masks are provided by one of a pre-trained other neural network, an algorithm providing semantic information and a transformer.

7. The method according to claim 1, further comprising:
providing an initial neural network trained based on an initial objective function not comprising the regularization term; and
training the initial neural network based on the objective function to obtain the neural network.

8. The method according to claim 7, further comprising training at least one of the neural network and the initial neural network with respect to the regularization term of the objective function in an unsupervised manner.

9. The method according to claim 8, wherein the training of the at least one of the neural network and the initial neural network is based on minimizing the objective function comprises:
obtaining an implicit representation of a training scene captured by one or more camera devices;
reconstructing the training scene based on the implicit representation of the training scene by volume rendering based on ray marching;
dividing the reconstructed training scene into reconstructed training scene patches;
applying, for selected ones of the reconstructed training scene patches, an SVD on a set of termination points of rays obtained by the ray marching; and
obtaining, for the selected reconstructed training scene patches, a respective smallest singular value of a singular matrix of the respective SVD; and wherein
the regularization term comprises a sum of smallest singular values of singular matrices of the SVDs applied to the sets of termination points of rays for the selected reconstructed training scene patches.

10. The method according to claim 9, wherein the regularization term comprises a real-valued weighting term larger than zero to control an influence of the regulation term on the objective function.

11. The method according to claim 1, wherein the at least one object has exactly one flat surface.

12. The method according to claim 11, wherein the at least one object is one of at least a part of a road, a street, a lane, and a sidewalk.

13. The method according to claim 1, further comprising:
generating a High Definition (HD) map using the reconstructed at least one object.

14. The method according to claim 1, further comprising:
labelling a High Definition (HD) map using the reconstructed at least one object.

15. The method according to claim 1, wherein the at least one object is a road, a street or a lane.

16. The method according to claim 15, wherein the method is used for autonomously driving a vehicle based on the reconstructed at least one object.

17. A non-transitory computer-readable medium, having computer-executable instructions stored thereon, the computer-executable instructions, when executed by one or more processors, perform or control the operations of the method according to claim 1.

18. A method, comprising:
receiving, by a neural network executed by a processing system, input data based on a plurality of images captured by at least one camera device representing an environment of the at least one camera device; and
obtaining, by the neural network executed by the processing system, an implicit representation of the environment based on the input data, wherein the neural network is trained based on an objective function comprising a regularization term based on Singular Value Decomposition (SVD).
